(19) United States
(12) Patent Application Publication
(10) Pub. No.: US 2026/0169202 A1
(43) Pub. Date: Jun. 18, 2026

(54) SURFACE MICROSTRUCTURE AND MOLDING PROCESS THEREOF AND APPLICATION THEREOF

(71) Applicants: SHENZHEN EVERWIN PRECISION TECHNOLOGY CO., LTD., SHENZHEN (CN); FORBETTER NEW MATERIAL SOLUTIONS CO., LTD., DONGGUAN (CN)

(72) Inventors: RUI SUN, SHENZHEN (CN); LIANSHOU LI, SHENZHEN (CN); GHEW HOONG SOON, SHENZHEN (CN); CHUANBAO CAI, SHENZHEN (CN)

(21) Appl. No.: 19/530,358

(22) Filed: Feb. 5, 2026

Related U.S. Application Data
(63) Continuation of application No. PCT/CN2024/107049, filed on Jul. 23, 2024.

(30) Foreign Application Priority Data
Aug. 11, 2023 (CN) 202311014070.8
Aug. 11, 2023 (CN) 202311014076.5

(51) Int. Cl. G02B 5/02; B29C 45/37; B29K 69/00; B29L 11/00

(52) U.S. Cl. CPC G02B 5/021; B29C 45/372; G02B 5/0284; B29K 2069/00; B29L 2011/0083

(57) ABSTRACT

A surface microstructure, a molding process thereof and an application thereof are provided. The surface microstructure includes a substrate integrally formed on a light-facing surface of a plastic product. The substrate includes a first surface arranged facing away from the light-facing surface of the plastic product and a microstructure layer integrally formed on the first surface of the substrate. The microstructure layer includes at least one first microstructure region. The at least one first microstructure region includes first microstructure units arranged on the substrate according to a first rule. Surfaces of the first microstructure units are spherical structures protruding in a direction away from the substrate. The substrate and the microstructure layer are integrally injection molded by a rapid cooling and heating process. The first microstructure units are compact and full, which effectively achieve diffuse reflection of incident light and reduce surface reflection.

### TECHNICAL FIELD

The present disclosure relates to a field of plastic surface diffuse reflection structure and molding technology, and in particular to a surface microstructure and a molding process thereof and an application thereof.

### BACKGROUND

A camera generally receives light reflected from a subject through an optical lens thereof to form an image, thereby enabling the recording of both dynamic and static images of the subject. To prevent the optical lens from receiving ineffective light or stray light from a surrounding environment, which could compromise imaging quality, a structure capable of reflecting or absorbing such ineffective or stray light is typically installed on a light-entry side of the camera. The structure is commonly made of plastic and has a flared shape to diffusely reflect ineffective or stray light at the light-entry side, preventing the reflect ineffective or stray light from entering the optical lens.

To enhance a reflection of the ineffective or stray light, current cameras typically employ a process where a plastic structure matched with the camera is first injection molded and then undergoes a flocking process to form a flocked layer on a light-facing surface of the camera. The flocked layer helps absorb or reflect incoming ineffective or stray light. However, a flocking process requires specialized equipment, which increases production costs. Additionally, the flocked layer, mostly composed of tiny fibers or fluff, tends to attract or accumulate dust over long-term use, potentially allowing dust to enter the optical lens and making cleaning difficult. Moreover, due to microscopic structures of the fibers or the fluff, the flocked layer may shed fibers during use, affecting imaging quality of the optical lens. Therefore, there is an urgent need to develop a surface microstructure and a molding process thereof to effectively refract and absorb the ineffective or stray light.

### SUMMARY

In view of defects in the prior art, the present disclosure provides a surface microstructure, a molding process thereof, and an application thereof to address issues in current flocking techniques, such as high processing costs, low processing efficiency, and tendency for flock to shed or attract dust. Further, the present disclosure achieves effective refraction and absorption of light.

In one embodiment, the present disclosure provides a surface microstructure. The surface microstructure comprises a substrate integrally formed on a light-facing surface of a plastic product. The substrate comprises a first surface arranged facing away from the light-facing surface of the plastic product and a microstructure layer integrally formed on the first surface of the substrate. The microstructure layer comprises at least one first microstructure region. The at least one first microstructure region comprises first microstructure units arranged on the substrate according to a first rule. Surfaces of the first microstructure units are spherical structures protruding in a direction away from the substrate.

In another embodiment, the present disclosure provides a molding process of a surface microstructure. The molding process comprises steps:
adding an injection molding raw material into a barrel, plasticizing the injection molding raw material to obtain an injection molding material and completing metering of the injection molding material;
closing a mold and preheating a surface of a mold cavity of the mold to a first preset temperature, wherein the first preset temperature is greater than a glass transition temperature (Tg temperature) of the injection molding material;
filling the injection molding material in the barrel into the mold cavity to form an injection molded part;
after the injection molded part is formed, switching the mold to a pressure holding state to perform pressure holding on the injection molded part;
opening a cooling channel after the pressure holding is completed, and cooling the mold and the injection molded part to a second preset temperature; and
opening the mold and ejecting the injection molded part.

In another embodiment, the present disclosure provides an application. The application comprises applying the surface microstructure described above and/or the surface microstructure prepared by the molding process on an inner surface of a plastic product, so as to enable diffuse reflection and absorption of incident light on the inner surface of the plastic product.

In another embodiment, the present disclosure provides an application. The application comprises applying the surface microstructure described above and/or the surface microstructure prepared by the molding process on a camera module, so as to reflect and absorb incident light that enters the camera module non-vertically.

In the present invention, the substrate and the microstructure layer are formed by injection molding using the mold and the rapid cooling and heating process to obtain the at least one first microstructure region and/or the at least one second microstructure region. Prior to filling the mold with the injection molding material, the mold and the surface of the mold cavity are preheated to the first preset temperature greater than the Tg temperature of the injection molding material. During a filling process of the injection molding material, the mold and the surface of the mold cavity are continuously heated at the first preset temperature, ensuring that the injection molding material (i.e., a plastic material) fully fills the mold cavity. In this way, a fullness and a height of the first microstructure units and the second microstructure units are enhanced. Additionally, the first microstructure units and the second microstructure units are arranged densely, so as to enable diffuse reflection of incident light on surfaces of the microstructure units, which reduces an entry of ineffective light and stray light into an optical lens of the camera module, solving the issues of severe reflection caused by concentrated beam reflection, and thereby improving the imaging quality of the camera module. Moreover, by forming at least one first microstructure forming region and at least one second microstructure forming region on an inner wall of the mold cavity to correspondingly shape the at least one first microstructure region and the at least one second microstructure region, the substrate and the microstructure units are integrally formed through a single injection molding process. The molding process requires only one mold, which saves process costs and improves molding efficiency.

Furthermore, a laser process is adopted to form the microstructure forming regions on the inner wall of the mold cavity, so that the surface microstructure and a main body of the plastic product are integrally formed in one process. A formed structure is stable, resistant to dust accumulation on a surface thereof, easy to clean, and eliminates a need to consider equipment compatibility issues, thus achieving high molding efficiency and lower costs.

### BRIEF DESCRIPTION OF DRAWINGS

FIG. 1 is a schematic diagram of a surface microstructure according to one embodiment of the present disclosure.

FIG. 2 is a top plan schematic diagram of the surface microstructure shown in FIG. 1.

FIG. 3 is a schematic diagram of a first microstructure region and a second microstructure region according to one embodiment of the present disclosure.

FIG. 4 is a top plan schematic diagram of the first microstructure region and the second microstructure region shown in FIG. 3.

FIG. 5 is a front side schematic diagram of the first microstructure region and the second microstructure region shown in FIG. 3.

FIG. 6 is a flow chart of a molding process of the surface microstructure according to one embodiment of the present disclosure.

FIG. 7 is a schematic diagram showing a comparison of temperature change curves of a mold during a molding process of the surface microstructure and a conventional molding process.

FIG. 8 is a surface radius map measured by scanning a bottom surface profile of the surface microstructure through a white light interferometer.

FIG. 9 is a schematic diagram showing a pit size measured by scanning the bottom surface profile of the surface microstructure through the white light interferometer.

FIG. 10 is a schematic diagram showing a pit roughness curve measured by scanning the bottom surface profile of the surface microstructure through the white light interferometer.

FIG. 11 is a schematic diagram showing images of the surface microstructure magnified 5 to 50 times by a metallurgical microscope.

FIG. 12 is a schematic diagram showing structural dimensions of the surface microstructure measured by an image measuring instrument with a repeatability accuracy of 0.1 μm.

FIG. 13 is a schematic diagram showing the structural dimensions of the surface microstructure manufactured by a conventional process.

FIG. 14 is a schematic diagram showing a maximum surface profile curve of the surface microstructure obtained by a profile measuring instrument.

FIG. 15 is a schematic diagram of a plastic product including the surface microstructure of the present disclosure.

FIG. 16 is a schematic diagram of modeling and simulation for diffuse reflection characteristics of the surface microstructure of the present disclosure.

### DETAILED DESCRIPTION

The following provides further detailed explanation through specific implementation methods:

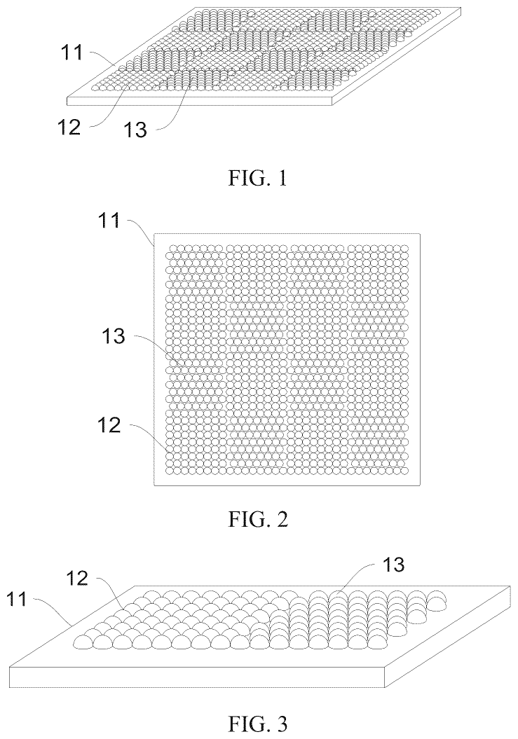

As shown in FIGS. 1-2, FIGS. 1-2 are schematic diagrams of a surface microstructure according to one embodiment of the present disclosure. The surface microstructure comprises a substrate 11 and a microstructure layer formed on the substrate 11. The substrate 11 has a first surface and a second surface arranged opposite to the first surface. The microstructure layer is formed on the first surface and possesses a certain degree of roughness to diffusely reflect light incident on the microstructure layer, thereby reflecting and absorbing ineffective light and stray light and reducing the occurrence of reflection phenomena. In the embodiment, both the substrate 11 and the microstructure layer are formed by injection molding of plastic material (e.g., polycarbonate (PC)). The microstructure layer is integrally formed on the substrate 11, so that the substrate 11 and the microstructure layer are allowed to be manufactured in a single process flow by using a same mold, thereby reducing process costs and improving process efficiency.

To improve the roughness of the microstructure layer, a rapid cooling and heating process is employed during an injection molding of the microstructure layer. Prior to injecting the plastic material into the mold cavity, the mold and the surface of the mold cavity are preheated to a temperature above a glass transition temperature (Tg temperature) of the plastic material. During injection, the mold and the surface of the mold cavity are continuously maintained at a temperature not less than the Tg temperature of the plastic material, so that the plastic material is fully filled into the mold cavity under high temperature, ensuring a fullness and a height of the microstructure layer and ensuring that dimensions of the microstructure layer meet design requirements. Furthermore, in the embodiment, during the molding of the microstructure layer (including the substrate 11), a molding temperature is between 130° C. and 180° C. Optionally, the molding temperature is 145° C. to ensure that the mold cavity is fully filled by the plastic material. A molding power ranges from 8 kilowatt (KW) to 15 KW. Optionally, the molding power is 10 KW to ensure rapid heating of the mold and the surface of the mold cavity to the molding temperature in a short period, thereby improving molding efficiency. In the embodiment, a thickness of the substrate 11 is 1.5-2.5 mm, preferably 2 mm, while the thickness of the microstructure layer is 0.07-0.09 mm. Optionally, a thickness of the substrate 11 is 0.08 mm, which allows the microstructure layer to possess sufficient roughness to achieve diffuse reflection of light.

Optionally, the microstructure layer has a concave curved structure. The concave curved structure facilitates light convergence, allowing incoming light to be gathered upon striking the surface of the microstructure layer and then reflected and absorbed by at least one first microstructure region 12, thereby enhancing the diffuse reflection and absorption of the light.

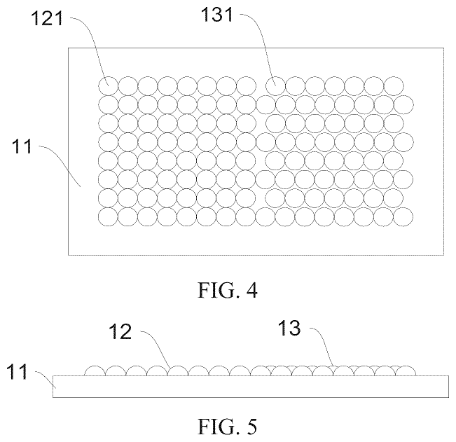

As shown in FIGS. 3-5, the microstructure layer comprises at least one first microstructure region 12. The at least one first microstructure region 12 comprises first microstructure units 121 arranged on the substrate 11 according to a first rule. Each of the first microstructure units 121 is configured as an independent structure to reflect and absorb light. In the embodiment, the first microstructure units 121 are arranged in an array. Optionally, the first microstructure units 121 are arranged in a rectangular array with M rows and N columns. A connecting line connecting geometric centers of projections of each row of the first microstructure units 121 on the first surface are orthogonal to a connecting line connecting geometric centers of projections of each column of the first microstructure units 121 on the first surface (i.e., the first rule). In other words, the projections of the geometric centers of any two adjacent rows or any two adjacent columns of the first microstructure units 121 onto a vertical plane perpendicular to the first surface are coincided with each other. In this way, diffuse reflection occurs within the at least one first microstructure region 12, scattering the light incident on the surfaces of the first microstructure units 121 in various directions, thereby improving a light reflection effect. It is understood that in other embodiments, the first microstructure units 121 may be arranged in a circular array, a sector array, or other polygonal array to achieve light reflection.

In the embodiment, each of the first microstructure units 121 is generally configured as a spherical structure protruding away from the substrate 11. A radius of a projection of each of the first microstructure units 121 on the first surface is 75(1±15%) μm, preferably 75 μm. A height of the projection of each of the first microstructure units 121 on the vertical plane perpendicular to the first surface is 75(1±10%) μm, preferably 75 μm. In the embodiment, a radius of each of the first microstructure units 121 gradually decreases from a contact point with the substrate 11 in a direction away from the substrate 11. As a result, each of the first microstructure units 121 presents a hemispherical shape. That is, each of the first microstructure units 121 has a spherical surface, thereby ensuring that the light is effectively absorbed or reflected. In other embodiments, the radius of the projection of each of the first microstructure units 121 on the first surface differs from the height of its projection on the vertical plane perpendicular to the first surface, so that each of the first microstructure units 121 is in a semi-ellipsoidal shape, which changes a reflection path of the light incident on a surface of each of the first microstructure units 121. Specifically, a tolerance between the radius of the projection of each of the first microstructure units 121 on the first surface and the height of the projection of each of the first microstructure units 121 on the vertical plane perpendicular to the first surface is controlled within ±10%. That is, a height tolerance of the projection of each of the first microstructure units 121 on the vertical plane perpendicular to the first surface satisfies a relation:

$$R * 90 \% \leq H \leq R * 110 \% .$$

R is the radius of the projection of each of the first microstructure units 121 on the first surface, and H is the height of the projection of each of the first microstructure units 121 on the vertical plane perpendicular to the first surface.

It is understood that in other embodiments, each of the first microstructure units 121 may be a cubic structure protruding away from the first surface, such as a polyhedral structure.

Optionally, structures of the first microstructure units 121 in the embodiment are identical. That is, all of the first microstructure units 121 are either in the hemispherical shape or in the semi-ellipsoidal shape. Further, a distance between the geometric centers of the projections of each two adjacent rows and/or each two adjacent columns of the first microstructure units 121 on a horizontal plane (i.e., the first surface) is 0.14-0.18 mm, preferably 0.16 mm. In this way, it ensures stable reflection of the light incident on the first microstructure units 121 while reducing complexity of a manufacturing process and a mold opening process. Certainly, when manufacturing challenges, mold opening complexity, and manufacturing costs are not considered, the at least one first microstructure region 12 may be a mixed structure including the first microstructure units in hemispherical, semi-ellipsoidal, other spherical, and/or polyhedral shapes, which increase irregularity of light reflection, thereby increasing a reflectivity of the light.

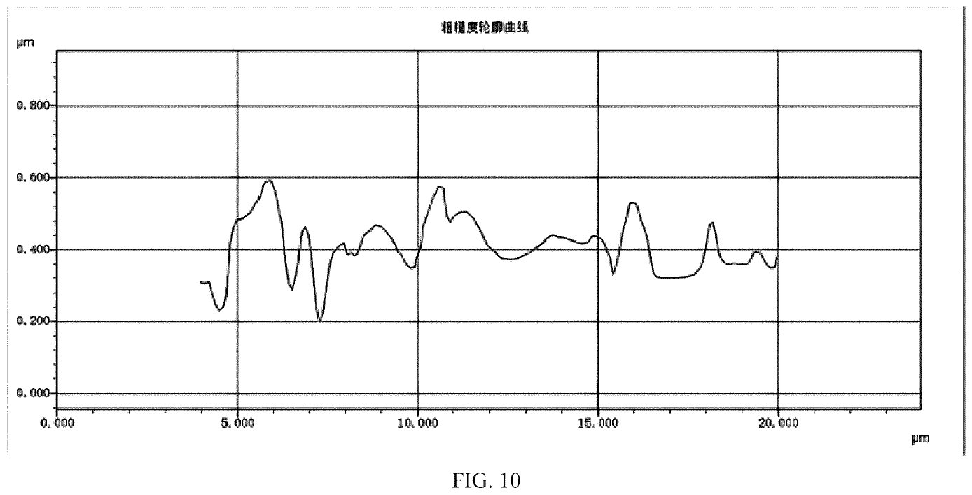

In the embodiment, a surface roughness Ra of a bottom surface of any one of the first microstructure units 121 of the at least one first microstructure region 12 is not less than 0.1 μm. That is, Ra≥0.1 μm. A peak roughness Rp of a surface roughness curve reaches up to 0.8 μm (as shown in FIG. 10), enabling diffuse reflection of the light incident on the at least one first microstructure region 12. Then, ineffective light and stray light are reflected or absorbed, thereby reducing an occurrence of glare.

In one optional embodiment, the microstructure layer may further comprise at least one second microstructure region 13 integrally formed on the substrate 11. The at least one second microstructure region 13 is located adjacent to the at least one first microstructure region 12. When both the at least one first microstructure region 12 and the at least one second microstructure region 13 are arranged on the substrate 11 and are arranged in an interlaced array. The at least one second microstructure region 13 has a different arrangement pattern from the at least one first microstructure region 12, resulting in different surface roughness levels. In this way, it ensures that when light irradiates on the at least one first microstructure region 12 and the at least one second microstructure region 13, irregular reflection occurs due to distinct structures of the at least one first microstructure region 12 and the at least one second microstructure region 13, thereby increasing the number of light reflections and enhancing the overall reflectivity.

In this embodiment, first microstructure regions 12 and second microstructure regions 13 are formed on the substrate 11. The first microstructure regions 12 and the second microstructure regions 13 are arranged in an array, causing the light irradiating on the first microstructure regions 12 and the second microstructure regions 13 to be reflected in various directions, thereby increasing the number of reflections and enhancing an ability of the microstructure layer to attenuate and reflect light. Optionally, the first microstructure regions 12 and the second microstructure regions 13 are arranged in an interlaced manner, thereby further enhancing the irregularity of light reflection. It is understood that in other embodiments, positions of first microstructure forming regions and second microstructure forming regions in the mold cavity of the mold corresponding to the first microstructure regions 12 and the second microstructure regions 13 are allowed to be adjusted during a mold design phase according to requirements. Therefore, the first microstructure regions 12 and the second microstructure regions 13 are arranged on the substrate 11 in corresponding positions and rules, such as being arranged in circular arrays, horizontal interlacing, vertical interlacing, etc. Alternatively, in some embodiments, only one first microstructure region 12 or only one second microstructure regions 13 are provided to achieve light reflections.

Each of the second microstructure regions 13 comprises second microstructure units 131 arranged on the substrate 11 according to a second rule. Each of the second microstructure units 131 is configured as an independent structure to reflect light. In the embodiment, the second microstructure units 131 are arranged into m rows. Between each two adjacent rows of the second microstructure units 131, an included angle between a connecting line connecting geometric centers of projections of each row of the second microstructure units 131 on the horizontal plane and a connecting line connecting geometric centers of projections of each column of the second microstructure units 131 on the horizontal plane is less than 90° (i.e., the second rule). In other words, for any two adjacent rows of the second microstructure units 131, a projection of a geometric center of any one of the second microstructure units in a rear row onto the vertical plane perpendicular to the horizontal plane is on the connecting line connecting the projections of the geometric centers of corresponding two adjacent second microstructure units in the front row of the second microstructure units onto the vertical plane. Optionally, the included angle is 45°. Further, the projection of the geometric center of any one of the second microstructure units in the rear row onto the vertical plane coincides with a midpoint of the connecting line connecting the projections of the geometric centers of the corresponding two adjacent second microstructure units in the front row of the second microstructure units onto the vertical plane. Diffuse reflection occurs in the second microstructure regions 13, reflecting light incident on the surfaces of the second microstructure units 131 in various directions to enhance the light reflection effect. It is understood that in other embodiments, the second microstructure units 131 are also arranged in an array, such as a rectangular array, a circular array, a sector array, or other polygonal array, similar to the first microstructure units 121, to reflect light. Similarly, the first microstructure units 121 may also be arranged in the second rule as the second microstructure units, where adjacent rows are staggered.

In the embodiment, each of the second microstructure units 131 is generally configured as a spherical structure protruding away from the substrate 11. A radius of a projection of each of the second microstructure units 131 on the first surface is 75(1±15%) μm, preferably 75 μm. A height of the projection of each of the second microstructure units 131 on the vertical plane perpendicular to the first surface is 75(1±10%) μm, preferably 75 μm. In the embodiment, a radius of each of the second microstructure units 131 gradually decreases from a contact point with the substrate 11 in a direction away from the substrate 11. As a result, each of the second microstructure units 131 presents a hemispherical shape. That is, each of the second microstructure units 131 has a spherical surface, thereby ensuring that the light is effectively absorbed or reflected. In other embodiments, the radius of the projection of each of the second microstructure units 131 on the first surface differs from the height of its projection on the vertical plane perpendicular to the first surface, so that each of the second microstructure units 131 is in a semi-ellipsoidal shape, which changes a reflection path of the light incident on a surface of each of the second microstructure units 131. Specifically, a tolerance between the radius of the projection of each of the second microstructure units 131 on the first surface and the height of the projection of each of the second microstructure units 131 on the vertical plane perpendicular to the first surface is controlled within ±10%. That is, a height tolerance of the projection of each of the second microstructure units 131 on the vertical plane perpendicular to the first surface satisfies a relation:

$${R}^{′} * 90 \% \leq {H}^{′} \leq {R}^{′} * 110 \% .$$

R′ is the radius of the projection of each of the second microstructure units 131 on the first surface, and H′ is the height of the projection of each of the second microstructure units 131 on the vertical plane perpendicular to the first surface.

It is understood that in other embodiments, each of the second microstructure units 131 may be a cubic structure protruding away from the first surface, such as a polyhedral structure.

Optionally, structures of the second microstructure units 131 in the embodiment are identical. That is, all of the second microstructure units 131 are either in the hemispherical shape or in the semi-ellipsoidal shape. Further, a distance between the geometric centers of the projections of each two adjacent rows and/or each two adjacent columns of the second microstructure units 131 on the horizontal plane (i.e., the first surface) is 0.14-0.18 mm, preferably 0.16 mm. In this way, it ensures stable reflection of the light incident on the second microstructure units 131 while reducing the complexity of the manufacturing process and the mold opening process. Certainly, when the manufacturing challenges, mold opening complexity, and manufacturing costs are not considered, each of the second microstructure regions 13 may be a mixed structure including the second microstructure units in hemispherical, semi-ellipsoidal, other spherical, and/or polyhedral shapes, which increase the irregularity of light reflection, thereby increasing the reflectivity of the light.

In the embodiment, a surface roughness Ra of a bottom surface of any one of the second microstructure unit 131 of the second microstructure regions 13 is not less than 0.1 μm. That is, Ra≥0.1 μm. A peak roughness Rp of a surface roughness curve reaches up to 0.8 μm (as shown in FIG. 10), enabling diffuse reflection of the light incident on the second microstructure regions 13. Then, ineffective light and stray light are reflected or absorbed, thereby reducing an occurrence of glare.

It is understood that in other embodiments, each of the first microstructure regions 12 comprises first microstructure-forming grooves. Each of the second microstructure regions 13 comprises second microstructure-forming grooves. The first microstructure-forming grooves and the second microstructure-forming grooves are arranged in an array such as a rectangular array, a circular array, a sector array, other polygonal array, and/or staggered arrangement to constitute each of the first microstructure regions 12 and each of the second microstructure regions 13. Inner walls of the first microstructure-forming grooves and inner walls of the second microstructure-forming grooves reflect the incident light.

In the embodiment, an area of each of the first microstructure regions 12 and/or each of the second microstructure regions 13 is 20-30 cm², with a shape of each of the first microstructure regions 12 and/or each of the second microstructure regions 13 optionally being square. Optionally, a side length of each of the first microstructure regions 12 and each of the second microstructure regions 13 is 5 cm. That is, the area of each of the first microstructure regions 12 and the area of each of the second microstructure regions 13 is 25 cm². It is understood that in other embodiments, each of the first microstructure regions 12 is arranged adjacent to a corresponding second microstructure region 13. Furthermore, each of the first microstructure regions 12 and each of the second microstructure regions 13 may also be configured in other shapes, such as a rectangle, a circle, a sector, a triangle, or other polygon, etc.

Optionally, to mold the first microstructure regions 12 and the second microstructure regions 13, a design and machining of an injection mold must be carried out based on a specific structure, dimensions, and an arrangement of the surface microstructure, so as to form the mold cavity with the microstructure forming regions corresponding to the surface microstructure in the injection mold. In the embodiment, the mold cavity of the injection mold comprises a first forming surface corresponding to an inner surface of a molded surface microstructure (i.e., a side surface of the microstructure layer) and a second forming surface corresponding to an outer surface of the molded surface microstructure (i.e., a side surface of the substrate 11). On the first forming surface, the first microstructure forming regions corresponding to the first microstructure regions 12 and/or second microstructure regions corresponding to the second microstructure regions 13 are formed by a laser process. The first microstructure regions comprise first microstructure-forming grooves corresponding to the first microstructure units 121, and the second microstructure regions comprise second microstructure-forming grooves corresponding to the second microstructure units 131. During the injection of the plastic material, the mold and the mold cavity are preheated and maintained at the molding temperature, ensuring the plastic material fully fills the first microstructure-forming grooves in the first microstructure regions and the second microstructure-forming grooves in the second microstructure regions, thereby accurately forming the first microstructure regions 12 and/or the second microstructure regions 13.

In the surface microstructure of the present disclosure, the rapid cooling and heating process is performed to form the first microstructure units 121 and/or the second microstructure units 131 on the substrate 11, which ensures that the plastic material fully fills the mold cavity upon entry, thereby increasing the fullness of the first microstructure units 121 and the second microstructure units 131. Therefore, the incident light on the first microstructure units 121 and the second microstructure units 131 undergoes multiple reflections, enhancing the light reflection effect and reducing ineffective and stray light. Moreover, since the first microstructure units 121 and the second microstructure units 131 are integrally injection-molded with the substrate 11 by using the plastic material, the surface of the formed microstructure layer resists dust accumulation and is easy to clean, maintaining a clean and pristine appearance even after prolonged use while delivering high light reflection efficiency.

In one optional embodiment, the invention provides a molding process of the surface microstructure. The molding process of the surface microstructure in the embodiment is configured to integrally form the surface microstructure on a light-facing surface of the plastic product (particularly a flare-shaped plastic product mounted on a light-entry side of a camera module). The molding process results in a fully formed microstructure that meets design dimensions. The surface microstructure causes incident light to undergo diffuse reflection. reduces reflection effects, and prevents ineffective and stray light from entering the camera module. It is understandable that although the embodiment primarily describes the molding of the surface microstructure of the flare shape on the plastic product, a shape of the surface microstructure is not limited thereto. The molding processes is also allowed to be applied to other plastic products, or even metal products that require the surface microstructure, thereby obtaining the surface microstructure that is structurally robust and meets design dimensions.

During specific implementation, the design and the machining of the injection mold is carried out based on the specific structure, dimensions, and the arrangement of the surface microstructure, so as to form the mold cavity with the microstructure forming regions corresponding to the surface microstructure in the injection mold. In the embodiment, the mold cavity of the injection mold comprises the first forming surface corresponding to the inner surface of the molded surface microstructure (i.e., the microstructure layer) and the second forming surface corresponding to the outer surface of the molded surface microstructure (i.e., the substrate 11). On the first forming surface, the first microstructure forming regions corresponding to the first microstructure regions 12 and/or second microstructure regions corresponding to the second microstructure regions 13 are formed by a laser process, thereby accurately forming the first microstructure regions 12 and/or the second microstructure regions 13.

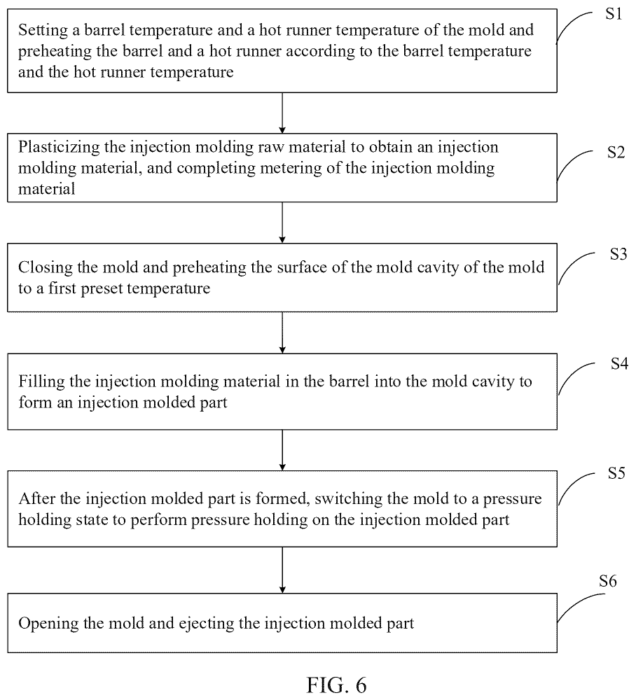

FIG. 6 is a flow chart of a molding process of the surface microstructure according to one embodiment of the present disclosure. As shown in FIG. 6, the molding process comprises steps S1-S7.

The step S1 comprises setting a barrel temperature and a hot runner temperature of the mold and preheating a barrel and a hot runner according to the barrel temperature and the hot runner temperature.

Based on the material and thermal melting properties of the injection molding raw material, the barrel temperature and the hot runner temperature of the mold are set, and the barrel and the hot runner are respectively preheated to the barrel temperature and the hot runner temperature. In the embodiment, according to a flow and plasticization process of the injection molding raw material, the barrel is sequentially divided into a nozzle section, a fourth heating section, a third heating section, a second heating section, a first heating section, and a feeding port section. Since the injection molding raw material for molding the surface microstructure is the plastic material, temperatures corresponding to the nozzle section, the fourth heating section, the third heating section, the second heating section, the first heating section, and the feeding port section of the barrel are respectively 295-315° C., 295-315° C., 290-310° C., 280-300° C., 270-290° C., and 260-280° C. Additionally, the temperature of the hot runner is 290-330° C., so that the injection molding raw material is rapidly plasticized and flows within the barrel and the hot runner.

The step S2 comprises plasticizing the injection molding raw material to obtain an injection molding material and completing metering of the injection molding material.

Specifically, the injection molding raw material is added into the barrel through the feeding port section. Heating components (such as heating plates or heating coils) mounted on an outer side of the barrel heat the injection molding raw material, so that the injection molding raw material is plasticized to be the injection molding material. The injection molding material is then conveyed by a screw arranged inside the barrel. During a conveying process, the injection molding material is metered according to a material volume required to form the molded surface microstructure.

In the embodiment, a multi-stage metering method is performed on the injection molding material, with metering parameters switching based on positions of the screw for each stage. Specifically, a three-stage metering method is performed.

In a first metering stage, a rotation speed of the screw arranged inside the barrel is 60(1±20%) rpm, and a backpressure of the screw is 40(1±20%) kgf/cm². The screw moves backward from a starting position to a first metering position. Then, the screw parameters, such as the rotation speed and the backpressure of the screw, are quickly switched to those required for the second metering stage. The first metering position is 15±3 mm away from the starting position of the screw.

In a second metering stage, the rotation speed of the screw arranged inside the barrel is 60(1±20%) rpm, and the backpressure of the screw is 40(1±20%) kgf/cm². The screw continues moving backward from the first metering position to a second metering position. After reaching the second metering position, the screw parameters, such as the rotation speed and the backpressure of the screw, are quickly switched to those required for the third metering stage. The second metering position is 50±3 mm away from the starting position of the screw.

In a third metering stage (a metering completion stage), the rotation speed of the screw arranged inside the barrel is 60(1±20%) rpm, and the backpressure of the screw is 40(1±20%) kgf/cm². The screw continues moving backward from the second metering position to a third metering position (i.e., a metering completion position). After reaching the third metering position, the screw is retracted. The metering completion position is 58±3 mm away from the starting position of the screw. During a retraction process, a retraction distance of the screw is 5±3 mm, and a retraction rotation speed of the screw is 15*(1±20%) mm/s. After retraction, the screw is 63±3 mm away from the starting position, which is also defined as an initial position of the screw in a filling stage.

In the embodiment, the three-stage metering method effectively enhances the accuracy and stability of the metering of the injection molding material, thereby improving molding precision. It is understood that in other embodiments, the screw parameters, such as the rotation speed and the backpressure of the screw, are adjusted in real time based on precision and efficiency requirements to expedite the metering process. Alternatively, a single-stage metering method may be used, where the screw moves directly to the metering completion position (i.e., a target position) and is then retracted immediately to improve metering efficiency.

The step S3 comprises closing the mold and preheating the surface of the mold cavity of the mold to a first preset temperature.

After clamping a front mold (i.e., a cavity plate) and a rear mold (i.e., a core plate) of the mold, the surface of the mold cavity is preheated to the first preset temperature. The heating of the mold is achieved by installing heating plates or heating coils on the mold, or through heat exchange between the mold and a fluid circulating in a heating pipeline. The first preset temperature is greater than the Tg temperature of the injection molding material. In the embodiment, according to a type of the injection molding material, the first preset temperature is 135-145° C., and a heating power is 8-15 KW. In this way, the mold is rapidly heated to the first preset temperature in a short time, thereby improving molding efficiency.

In the embodiment, a multi-stage mold-closing method is adopted to close the front mold and the rear mold. The front mold and the rear mold move relative to each other under a second mold-closing pressure, then the second mold-closing pressure is switched to a first mold-closing pressure to cause the front mold and the rear mold to be tightly attached. The first mold-closing pressure is less than the second mold-closing pressure, and a mold-closing speed decreases during a relative movement of the front mold and the rear mold. The first mold-closing pressure is 230*30%(1±20%) TON. Specifically, a five-stage mold-closing method is performed.

In a first mold-closing stage, the front mold and the rear mold move relative to each other under the second mold-closing pressure of 230*(1±20%) TON and at 40-50% of the mold-closing speed to reach a first clamping position. The first clamping position is where two opposite surfaces of the front mold and the rear mold are 350±3 mm apart.

In a second mold-closing stage, the front mold and the rear mold move relative to each other under the second mold-closing pressure of 230*(1±20%) TON and at 35-45% of the mold-closing speed to reach a second clamping position. The second clamping position is where the two opposite surfaces of the front mold and the rear mold are 200±3 mm apart.

In a third mold-closing stage, the front mold and the rear mold move relative to each other under the second mold-closing pressure of 230*(1±20%) TON and at 25-35% of the mold-closing speed to reach a third clamping position. The third clamping position is where the two opposite surfaces of the front mold and the rear mold are 150±3 mm apart.

In a fourth mold-closing stage, the front mold and the rear mold move relative to each other under the second mold-closing pressure of 230*(1±20%) TON and at 20-30% of the mold-closing speed to reach a fourth clamping position. The fourth clamping position is where the two opposite surfaces of the front mold and the rear mold are 80±3 mm apart.

In a fifth mold-closing stage (i.e., a final mold locking stage), the front mold and the rear mold move relative to each other at 20-30% of the mold-closing speed to reach a mold locking position. The mold locking position is where the two opposite surfaces of the front mold and the rear mold are 3±3 mm apart. To prevent excessive pressure when the front mold and the rear mold are locked, the fifth mold-closing stage is divided into a high-pressure stage and a low-pressure stage. In the high-pressure stage, the front mold and the rear mold move relative to each other under the second mold-closing pressure of 230*(1±20%) TON to a low-pressure switch position. When reaching the low-pressure switch position, the front mold and the rear mold immediately move to the mold locking position at 20-30% of the mold-closing speed under the first mold-closing pressure of 230*30%*(1±20%) TON, thereby enhancing clamping stability. The low-pressure switch position is where the two opposite surfaces of the front mold and the rear mold are 30±3 mm apart.

In the embodiment, the five-stage mold-closing method is performed, so that the mold-closing speed gradually decreases and the mold-closing pressure is switched from high to low during the relative movement of the front mold and the rear mold. When the front mold and the rear mold are far apart, the mold-closing speed and the mold-closing pressure are relatively large, allowing the front mold and the rear mold to close toward each other rapidly. When the front mold and the rear mold area are close to each other, the mold-closing speed and the mold-closing pressure are switched to be relatively small for locking of the front mold and the rear mold. At this point, guide pins of the front mold and the rear mold are in contact. The mold-closing speed that is relatively small reduces mechanical vibration upon contact, thereby increasing clamping stability and lowering a risk of damage to the front mold and the rear mold caused by collision. As a result, service life of the mold is prolonged. It is understood that in other embodiments, the number of mold-closing stages, the mold-closing speeds, and the mold-closing pressure are determined based on a distance and a stroke between the front mold and the rear mold, so as to suit the injection molding of corresponding product structures.

The step S4 comprises filling the injection molding material in the barrel into the mold cavity to form an injection molded part.

When the mold is preheated to the first preset temperature and the metering of the injection molding material inside the barrel is completed, the screw is controlled to move to fill the injection molding material into the mold cavity from the barrel to form the injection-molded part.

In the embodiment, during filling, a multi-stage filling method is performed. The injection molding material is filled under a certain filling pressure and at a filling speed that first increases and then decreases, so as to quickly fill the mold cavity. Specifically, a three-stage filling method is implemented, with a screw position as a priority to determine whether the mold is switched to a pressure holding state from the filling stage.

In a first filling stage, the filling pressure is 2300*(1±20%) kgf/cm², and the filling speed is 20*(1±20%) mm/s. The screw conveys the injection molding material from the metering completion position (specifically, the retraction position of the screw after completing the metering) to a first filling position. The first filling position is 52±3 mm to a final position of the injection molding material.

In a second filling stage, the filling pressure is 2300*(1±20%) kgf/cm², and the filling speed is 45*(1±20%) mm/s. The screw conveys the injection molding material from the first filling position to a second filling position. The second filling position is 12±3 mm to the final position.

In a third filling stage, the filling pressure is 2300*(1±20%) kgf/cm², and the filling speed is 25*(1±20%) mm/s. The screw conveys the injection molding material from the second filling position to a pressure holding switch position, where the pressure holding switch position is 6±3 mm to the final position.

During a filling process, the mold and the surface of the mold cavity are continuously maintained at the first preset temperature until both filling and pressure holding are completed, so that the injection molding material is enabled to fully fill the mold cavity, increasing the fullness and height of the formed surface microstructure. The diffuse reflection of light is achieved through the surface microstructure and the molding process ensures that the dimensions of the formed surface microstructure meet the design requirements.

In the embodiment, the three-stage filling method is used, with the filling speed first increasing then decreasing. During the first filling stage, a slower filling speed allows a plasticized injection molding raw material (i.e., the injection molding material) to fill steadily, preventing defects such as flow marks, material splashing, or spiraling. In the second filling stage, a faster filling speed allows the injection molding material to quickly inject into the mold cavity, ensuring that the injection molding material overcomes resistance and fills completely in the mold cavity, thereby preventing material shortage. Finally, in the third filling stage, the filling speed decreases, the screw moves to the pressure holding switch position to avoid phenomena like overflow and indentation at a parting line between the front mold and the rear mold. It is understood that in other embodiments, the number of filling stages, the filling positions, and the filling speed are adaptively adjusted based on parameters such as the volume of the injection molding material and flow resistance.

In the embodiment, the screw position is determined as a priority signal for switching from the filling stage to the pressure holding stage. That is, when the screw reaches the pressure holding switch position, filling stops immediately, and the mold quickly switches to the pressure holding state. In this way, it is ensured that the injection molding material is fully filled and avoids issues like material shortage. However, with the screw position as the priority, the mold also has a maximum filling time, set to 3*(1±20%) s. Under the limit of the maximum filling time, and given the high temperature and pressure inside the mold, to ensure processing safety, when the maximum filling time is reached, the mold is quickly switched to the pressure holding state even if the screw has not yet reached the pressure holding switch position, which also ensures continuity of the molding process.

It is understood that in other embodiments, time is determined as the highest priority. In such cases, the filling time itself serves as the signal to control the mold to switch from the filling stage to the pressure holding stage. Once a set time is reached, the mold switches immediately to the pressure holding state, ensuring the efficiency and continuity of the molding process.

The step S5 comprises after the injection molded part is formed, switching to a pressure holding state to perform pressure holding on the injection molded part.

Once the injection molding material is filled, the mold is quickly switched to the pressure holding state to maintain pressure on the injection molded part within the mold. In the embodiment, during a pressure holding process, a segmented pressure holding method is adopted, and the injection molded part is held for a certain period of time with a certain holding pressure and pressure holding speed to control a deformation amount of injection molded part. Furthermore, a small amount of injection molding material continues to be injected during the pressure holding process to fill a shrinkage space during cooling and solidification of the injection molded part, thereby ensuring the molding quality of the formed surface microstructure. Specifically, a two-stage pressure holding method is used.

In a first pressure holding stage, the pressure holding speed is 25*(1±15%) mm/s, a holding time is 1.3*(1±20%) s, and a holding pressure is 1000*(1±15%) kgf/cm².

In a second pressure holding stage, the pressure holding speed is 25*(1±15%) mm/s, the holding time is 2*(1±20%) s, and the holding pressure is 900*(1±15%) kgf/cm².

In the embodiment, the two-stage pressure holding method is performed to apply segmented pressure holding to the injection molded part, which extends a holding time curve of the holding pressure, ensuring that the injection molded part does not crack. It is understood that in other embodiments, the number of pressure holding stages is specifically configured according to a structure of the formed surface microstructure to ensure the quality of the formed surface microstructure.

The step S6 comprises cooling the mold and the injection molded part to a second preset temperature.

After the pressure holding is completed, a cooling channel is opened to cool both the mold and the injection molded part to the second preset temperature, ensuring smooth demolding of the injection molded part. Fluid (gas, liquid, etc.) is circulated in the cooling channel to cool the mold and the injection molded part. Through circulating flow of the fluid, heat exchange with the mold and the injection molded part is carried out, thereby rapidly cooling the mold and the injection molded part. In the embodiment, a cooling time is 30*(1±20%) s, and the second preset temperature ranges from 85° C. to 95° C.

The step S7 comprises opening the mold and ejecting the injection molded part.

After the mold and injection molded part are cooled to the second preset temperature, the mold is opened to demold the injection molded part, thus completing the integral molding of the plastic product and the surface microstructure.

In the embodiment, when opening the mold, a multi-stage mold-opening method is applied to separate the front mold and the rear mold. During separation, the front mold and the rear mold move apart at a specific opening speed. A mold opening speed first increases and then decreases until a maximum opening position is reached, after which the injection molded part is ejected by an ejector pin. Specifically, a five-stage mold-opening method is performed.

In a first mold-opening stage, the front mold and the rear mold move relative to each other at 15-25% of a maximum mold opening speed to a first opening position. The first opening position is where the two opposite surfaces of the front mold and the rear mold are 35±3 mm apart.

In a second mold-opening stage, the front mold and the rear mold move relative to each other at 30-40% of the maximum mold opening speed to a second opening position. This second opening position is where the two opposite surfaces of the front mold and the rear mold are 85±3 mm apart.

In a third mold-opening stage, the front mold and the rear mold move relative to each other at 35-45% of the maximum mold opening speed to a third opening position. The third opening position is where the two opposite surfaces of the front mold and the rear mold are 160±3 mm apart.

In a fourth mold-opening stage, the front mold and the rear mold move relative to each other at 40-50% of the maximum mold opening speed to a fourth opening position. This fourth opening position is where the two opposite surfaces of the front mold and the rear mold are 400±3 mm apart.

In a fifth mold-opening stage (i.e., a mold-opening limit stage), the front mold and the rear mold move relative to each other at 20-30% of the maximum mold opening speed to a fifth opening position (i.e., a maximum opening limit position). This fifth opening position is where the two opposite surfaces of the front mold and the rear mold are 450±3 mm apart.

In the embodiment, the five-stage mold-opening method is performed. During the relative movement of the front mold and the rear mold, the mold opening speed first gradually increases and then gradually decreases. Specifically, in the first mold-opening stage, a lower mold opening speed is applied to separate the front mold and the rear mold, which avoids deformation of the injection molded part caused by air flow pulling on it during rapid separation of the front mold and the rear mold, thereby ensuring the shape and quality of the injection molded part. After the front mold separates from the rear mold, a larger mold opening speed is applied to quickly move the front mold and the rear mold away from each other, so as to shorten the mold opening time of the front mold and the rear mold. Finally, when the front mold and the rear mold are about to reach the maximum opening limit position, a smaller mold opening speed is applied to move the front mold and the rear mold to the maximum opening limit position, thereby reducing a mechanical vibration of an injection molding machine. It is understood that in other embodiments, the number of mold-opening stages and the mold opening speed are determined based on the distance and stroke between the front mold and the rear mold to adapt to the injection molding of products with specific structures.

The front mold and the rear mold are opened to the maximum opening limit position, thereby providing a moving space for the ejector pin to eject the injection molded part. When ejecting the injection molded part, the ejector pin performs at least one ejection stroke. Taking a single ejection stroke as an example, the ejector pin first extends to a first ejection position and dwells for a certain period, then extends further to a second ejection position and dwells for a certain period to complete the demolding of the injection molded part.

In the molding process of the surface microstructure of the present disclosure, the mold and the surface of the mold cavity are preheated to the first preset temperature above the Tg temperature of the injection molding material before filling the injection molding material. During the filling process, the mold and the surface of the mold cavity are maintained at the first preset temperature, which ensures that the injection molding material fully fills the mold cavity, thereby increasing the fullness and height of the formed surface microstructure. Furthermore, the surface microstructure and a main body of the plastic product are integrally formed in one process. A formed structure is stable, resistant to dust accumulation on a surface thereof, easy to clean, and eliminates a need to consider equipment compatibility issues, thus achieving high molding efficiency and lower costs.

The present disclosure is further illustrated below by taking a specific implementation process as an example. During implementation, it is preferable to use the PC material for the integral injection molding of the plastic product and the surface microstructure on the inner surface of the plastic product.

The molding process comprises steps S101-S107.

The step S10 comprises setting the barrel temperature and the hot runner temperature of the mold and preheating the barrel and the hot runner according to the barrel temperature and the hot runner temperature.

The molding temperature of the barrel at the nozzle section, the fourth heating section, the third heating section, the second heating section, the first heating section, and the feeding port section is 305° C., 305° C., 300° C., 290° C., 280° C., and 270° C., respectively. The molding temperature of the hot runner is 310° C.

The step S102 comprises plasticizing the injection molding raw material to obtain the injection molding material and completing metering of the injection molding material.

The rotation speed of the screw is set to 60 rpm and the backpressure is set to 40 kgf/cm². PC particles are added into the barrel. In the first metering stage and the second metering stage, the screw is respectively 15 mm and 50 mm away from the starting position. After completing metering, the screw is 58 mm away from the starting position, the screw is retracted by 5 mm at a speed of 15 m/s. Then, the screw stops at a position 63 mm away from the final position, which serves as the initial position of the screw during the filling stage.

The step S103 comprises closing the mold and preheating the surface of the mold cavity of the mold to the first preset temperature.

The front mold and rear mold of the mold are moved to close the mold.

In the first mold-closing stage, the front mold and the rear mold move relative to each other under the second mold-closing pressure of 230 TON and at 45% of the mold-closing speed to reach the first clamping position. The first clamping position is where the two opposite surfaces of the front mold and the rear mold are 350 mm apart.

In the second mold-closing stage, the front mold and the rear mold move relative to each other under the second mold-closing pressure of 230 TON and at 40% of the mold-closing speed to reach the second clamping position. The second clamping position is where the two opposite surfaces of the front mold and the rear mold are 200 mm apart.

In the third mold-closing stage, the front mold and the rear mold move relative to each other under the second mold-closing pressure of 230 TON and at 30% of the mold-closing speed to reach the third clamping position. The third clamping position is where the two opposite surfaces of the front mold and the rear mold are 150 mm apart.

In the fourth mold-closing stage, the front mold and the rear mold move relative to each other under the second mold-closing pressure of 230 TON and at 25% of the mold-closing speed to reach the fourth clamping position. The fourth clamping position is where the two opposite surfaces of the front mold and the rear mold are 80 mm apart.

In the fifth mold-closing stage, the front mold and the rear mold move relative to each other under the second mold-closing pressure of 230 TON and at 25% of the mold-closing speed to reach a position where the two opposite surfaces of the front mold and the rear mold are 30 mm apart. Then, the front mold and the rear mold move relative to each other under the first mold-closing pressure of 230*30% TON and at 25% of the mold-closing speed to reach a position where the two opposite surfaces of the front mold and the rear mold are 2.4 mm apart, thereby closing the mold.

Then, the mold and the surface of the mold cavity are heated to 145° C. with the heating power of 10 KW.

The step S104 comprises filling the injection molding material in the barrel into the mold cavity to form an injection molded part.

The mold cavity is filled with the PC injection molding material from the barrel.

In the first filling stage, the filling pressure is 2300 kgf/cm², and the filling speed is 20 mm/s. The PC injection molding material is filled from 63 mm from the final position of the injection molding material to 52 mm from the final position of the injection molding material.

In the second filling stage, the filling pressure is 2300 kgf/cm², and the filling speed is 45 mm/s. The PC injection molding material is filled from 52 mm from the final position of the screw to 12 mm from the final position of the screw.

In the third filling stage, the filling pressure is 2300 kgf/cm², and the filling speed is 25 mm/s. The PC injection molding material is filled from 12 mm from the final position of the screw to 6 mm from the final position of the screw. Then, the mold is quickly switched to the pressure holding stage.

The step S105 comprises after the injection molded part is formed, switching to a pressure holding state to perform pressure holding on the injection molded part;

Apply pressure holding to the injection molded part.

In the first pressure holding stage, the pressure holding speed is 25 mm/s, a holding time is 1.3 s, and a holding pressure is 1000 kgf/cm².

In the second pressure holding stage, the pressure holding speed is 25 mm/s, the holding time is 2 s, and the holding pressure is 900 kgf/cm².

The step S106 comprises cooling the mold and the injection molded part to a second preset temperature.

After pressure holding is completed, the mold and the injection molded part are cooled to below 90° C.

The step S107 comprises opening the mold and ejecting the injection molded part.

The front mold and the rear mold are separated to open the mold.

In the first mold-opening stage, the front mold and the rear mold move relative to each other at 20% of the maximum mold opening speed to the first opening position. This first opening position is where the two opposite surfaces of the front mold and the rear mold are 35 mm apart.

In the second mold-opening stage, the front mold and the rear mold move relative to each other at 35% of the maximum mold opening speed to the second opening position. This second opening position is where the two opposite surfaces of the front mold and the rear mold are 85 mm apart.

In the third mold-opening stage, the front mold and the rear mold move relative to each other at 40% of the maximum mold opening speed to the third opening position. This third opening position is where the two opposite surfaces of the front mold and the rear mold are 160 mm apart.

In the fourth mold-opening stage, the front mold and the rear mold move relative to each other at 45% of the maximum mold opening speed to a fourth opening position. The fourth opening position is where the two opposite surfaces of the front mold and the rear mold are 400 mm apart.

In the fifth mold-opening stage, the front mold and the rear mold move relative to each other at 25% of the maximum mold opening speed to the fifth opening position. The fifth opening position is where the two opposite surfaces of the front mold and the rear mold are 450 mm apart.

Then, the ejector pin is controlled to first eject the injection molded part by 40 mm and hold for 1.2 s, then the injection molded part is ejected by 57 mm and hold for 1.2 s to complete the molding of the plastic product. The molding process is repeated to execute the next injection molding cycle.

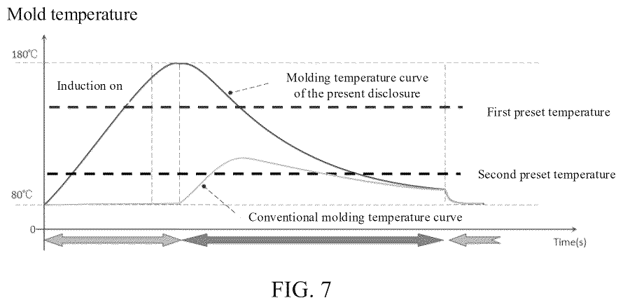

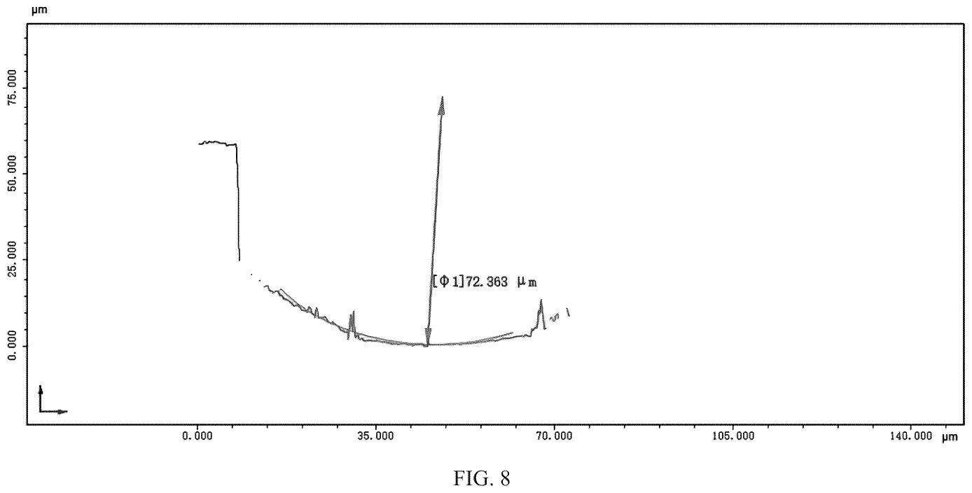

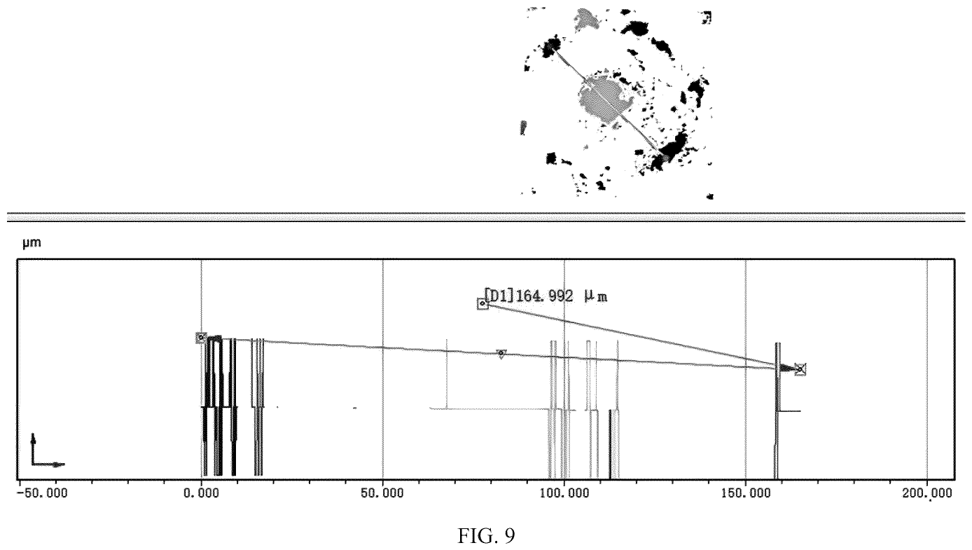

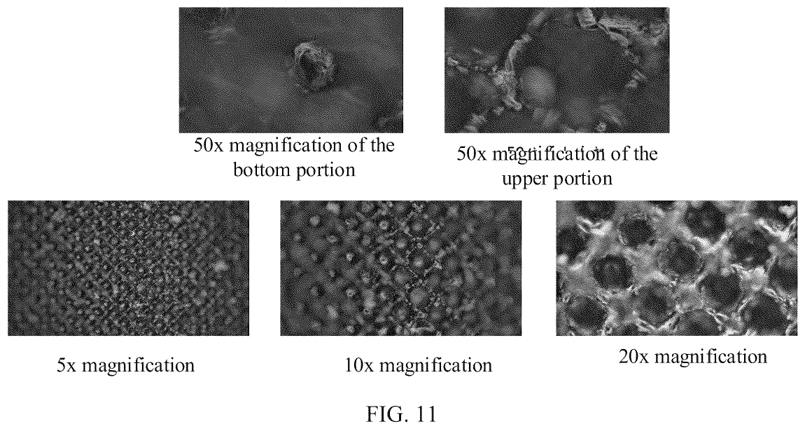

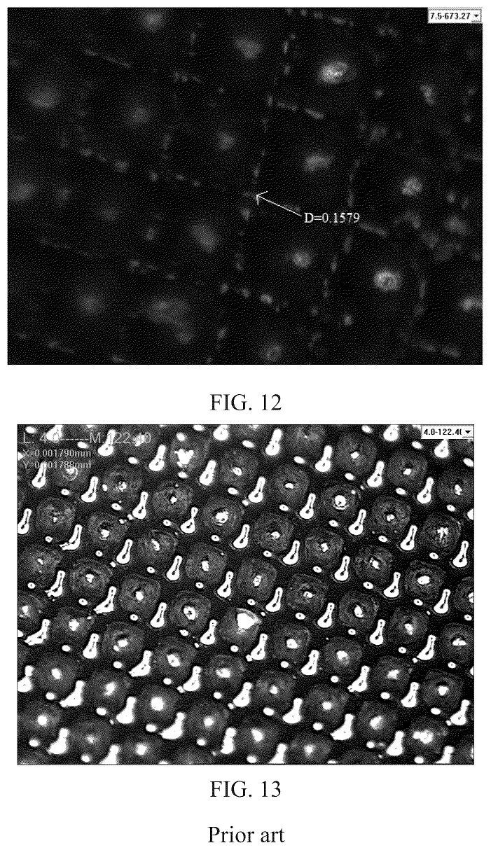

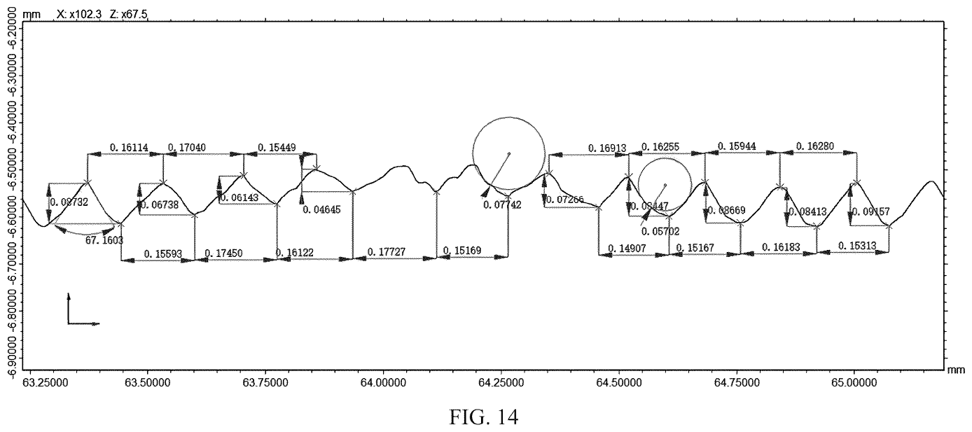

FIG. 7 is a schematic diagram showing a comparison of temperature change curves of a mold during a molding process of the surface microstructure and a conventional molding process. Combined with the measured surface radius, pit size and roughness obtained by scanning the bottom surface of the surface microstructure through a white light interferometer (as shown in FIGS. 8-10), the morphology and structural dimensions of the surface microstructure (as shown in FIGS. 11-12), and the maximum surface contour curve of the surface microstructure (as shown in FIG. 14), it is clearly observed from the figures that the surface microstructure of the present disclosure achieves greater forming height and roughness. Each of protrusions (i.e., the microstructure units) exhibits a full and well-defined shape, capable of effectively absorbing and reflecting incident light. Compared with the surface microstructure produced by the conventional process shown in FIG. 13, the protrusions in the surface microstructure of the present disclosure are arranged significantly more compactly, with smaller gaps, and exhibit fuller formation.

Another embodiment of the present disclosure provides an application of a surface microstructure on the inner surface of a plastic product, or an application of the molding process of the surface microstructure described in the above embodiments on the plastic product, to achieve diffuse reflection of incident light on the inner surface of the plastic product.

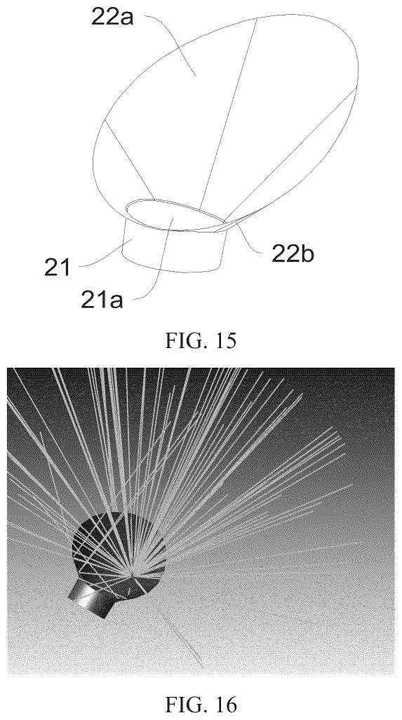

FIG. 15 is a schematic diagram of a plastic product including the surface microstructure of the present disclosure. As shown in FIG. 15, the plastic product is arranged on the light-incident side of a camera module and has an overall flared (horn-shaped) structure. This flared structure is able to gather light, and then the surface microstructure integrated thereon diffuses and reflects the incident light to reduce surface glare and prevent ineffective light and stray light from entering the camera module. It is understandable that although the embodiment mainly uses the flared plastic product to illustrate the application of the surface microstructure, the application of the surface microstructure is not limited thereto. The surface microstructure may be used on other plastic products or even metal products that require diffuse reflection.

Specifically, the plastic product comprises a main body 21 connected to the camera module. A light-passing hole 21a coaxial with an optical axis of the camera module is formed in the main body 21 of the plastic product. The main body 21 has a light-facing surface 22a facing inward (i.e., towards an axis direction of the light-passing hole or the optical axis of the camera module) and a back surface 22b opposite the light-facing surface 22a. The surface microstructure is integrally formed on the light-facing surface 22a to perform multiple reflections on light incident upon the light-facing surface 22a. In the embodiment, the surface microstructure is formed integrally with the plastic product. During the molding process, the main body 21 of the plastic product is formed by a conventional injection molding process, while the surface microstructure is formed by a rapid cooling and heating process. These two processes may be integrated and realized within the same set of mold. Specifically, molding compatibility between the two processes is achieved by adjusting the forming temperature at different process stages, thereby simplifying the process flow and reducing the difficulty for manufacturing both the plastic product and the surface microstructure.

FIG. 16 is a schematic diagram of modeling and simulation for diffuse reflection characteristics of the surface microstructure of the present disclosure. It can be seen that parallel light directly incident on the surface microstructure undergoes multiple reflections, but very little light enters a lens below.

Another embodiment of the present disclosure provides an application of a plastic product having the surface microstructure on the camera module. By arranging the plastic product having the surface microstructure on the light-incident side of the lens of the camera module. The, it is used is configured to reflect and absorb light not perpendicularly incident onto the lens, thereby reducing glare. The light-passing hole on the plastic product is arranged coaxially with the optical axis of the lens. The surface microstructure on the plastic product is able to reflect the incident light, thereby reducing ineffective light or stray light entering the lens and improving the imaging quality of the camera module.

What is claimed is:

1. A surface microstructure, comprising:
a substrate integrally formed on a light-facing surface of a plastic product,
wherein the substrate comprises a first surface arranged facing away from the light-facing surface of the plastic product and a microstructure layer integrally formed on the first surface of the substrate,
wherein the microstructure layer comprises at least one first microstructure region, the at least one first microstructure region comprises first microstructure units arranged on the substrate according to a first rule, and surfaces of the first microstructure units are spherical structures protruding in a direction away from the substrate.

2. The surface microstructure according to claim 1, wherein the microstructure layer and the substrate are integrally formed into the plastic product, and the surface microstructure is formed by a rapid cooling and heating process.

3. The surface microstructure according to claim 2, wherein a radius of a projection of each of the first microstructure units on the first surface of the substrate is 75*(1±15%) μm, and a height tolerance of the projection of each of the first microstructure units on a plane perpendicular to the first surface of the substrate satisfies:
$$R * 90 \% \leq H \leq R * 110 \% ;$$
wherein R is the radius of the projection of each of the first microstructure units on the first surface of the substrate, and H is a height of the projection of each of the first microstructure units on the plane perpendicular to the first surface of the substrate.

4. The surface microstructure according to claim 1, wherein the first microstructure units are distributed in an array into M rows and N columns; wherein a connecting line of geometric centers of projections of each row of the first microstructure units on the first surface is orthogonal to a connecting line of geometric centers of projections of each column of the first microstructure units on the first surface, and a distance between the geometric centers of the projections of each two adjacent rows of the first microstructure units and/or each two adjacent columns of the first microstructure units on the first surface of the substrate is 0.14-0.18 mm.

5. The surface microstructure according to claim 1, wherein the microstructure layer further comprises at least one second microstructure region integrally formed on the substrate, and the least one second microstructure region is adjacent to the at least one first microstructure region;
wherein the at least one second microstructure region comprises second microstructure units arranged on the substrate according to a second rule, and a surface of each of the second microstructure units is a spherical structure protruding in the direction away from the substrate.

6. The surface microstructure according to claim 5, wherein a radius of a projection of each of the second microstructure units on the first surface of the substrate is 75*(1±15%) μm, and a height tolerance of the projection of each of the second microstructure units on a plane perpendicular to the first surface of the substrate satisfies:
$${R}^{′} * 90 \% \leq {H}^{′} \leq {R}^{′} * 110 \% ;$$
wherein R′ is the radius of the projection of each of the second microstructure units on the first surface of the substrate, and H′ is a height of the projection of each of the second microstructure units on the plane perpendicular to the first surface of the substrate.

7. The surface microstructure according to claim 5, wherein the second microstructure units are distributed into M rows and N columns;
wherein in each two adjacent rows of the second microstructure units, an included angle between a connecting line of geometric centers of projections of each row of the second microstructure units on the first surface and a connecting line of geometric centers of projections of each column of the second microstructure units on the first surface of the substrate is less than 90 degrees, and a distance between the geometric centers of the projections of each two adjacent rows of the second microstructure units and/or each two adjacent columns of the second microstructure units on the first surface of the substrate is 0.14-0.18 mm.

8. The surface microstructure according to claim 5, wherein a surface roughness Ra of a bottom surface of any one of the first microstructure units and the second microstructure units is not less than 0.1 μm.

9. A molding process of a surface microstructure, comprising steps:
adding an injection molding raw material into a barrel, plasticizing the injection molding raw material to obtain an injection molding material and completing metering of the injection molding material;
closing a mold and preheating a surface of a mold cavity of the mold to a first preset temperature, wherein the first preset temperature is greater than a glass transition temperature (Tg temperature) of the injection molding material;
filling the injection molding material in the barrel into the mold cavity to form an injection molded part;
after the injection molded part is formed, switching the mold to a pressure holding state to perform pressure holding on the injection molded part;
opening a cooling channel after the pressure holding is completed, and cooling the mold and the injection molded part to a second preset temperature; and
opening the mold and ejecting the injection molded part.

10. The molding process according to claim 9, wherein before the step of adding the injection molding raw material into the barrel, plasticizing the injection molding raw material to obtain the injection molding material and completing metering of the injection molding material, the molding process further comprises:
setting a barrel temperature and a hot runner temperature of the mold and preheating the barrel and a hot runner according to the barrel temperature and the hot runner temperature;
wherein the barrel comprises a feeding port section, a first heating section, a second heating section, a third heating section, a fourth heating section, and a nozzle section that are sequentially arranged; the barrel temperature of the barrel at the nozzle section, the fourth heating section, the third heating section, the second heating section, the first heating section and the feeding port section are respectively 295-315° C., 295-315° C., 290-310° C., 280-300° C., 270-290° C. and 260-280° C., and the hot runner temperature is 290-330° C.

11. The molding process according to claim 9, wherein in the step of adding the injection molding raw material into the barrel, plasticizing the injection molding raw material to obtain the injection molding material and completing metering of the injection molding material, during metering of the injection molding material, a multi-stage metering method is performed;
wherein during metering of the injection molding material, a rotation speed of a screw arranged inside the barrel is 60*(1±20%) rpm, a backpressure is 40*(1±20%) kgf/mm², after the metering is completed, the screw retracts with a retraction distance of 5±3 mm and a retraction speed of 15*(1±20%) mm/s.

12. The molding process according to claim 9, wherein in the step of closing the mold and preheating the surface of the mold cavity of the mold to the first preset temperature, a multi-stage mold-closing method is performed;
when closing the mold, a front mold and a rear mold of the mold move relative to each other under a first mold-closing pressure until they reach a first clamping position, then the front mold and the rear mold of the mold move relative to each other at a second mold-closing pressure until the mold is closed;
wherein the first mold-closing pressure is greater than the second mold-closing pressure, the first mold-closing pressure is 230*30%*(1±20%) TON, and a mold-closing speed decreases as the front mold and the rear mold move relative to each other.

13. The molding process according to claim 9, wherein in the step of closing the mold and preheating the surface of the mold cavity of the mold to the first preset temperature, the first preset temperature is 135-145° C., and a heating power is 8-15 kilowatt (KW).

14. The molding process according to claim 9, wherein in the step of filling the injection molding material in the barrel into the mold cavity to form the injection molded part; a multi-stage filling method is performed;
wherein during filling, in a first filling stage, a filling pressure is 2300*(1±20%) kgf/cm², a filling speed is 20*(1±20%) mm/s, the injection molding material is transferred from a metering completion position of a screw until the screw reaches a first filling position, wherein the first filling position is 52±3 mm away from a final position to be reached by the injection molding material, and a maximum filling period for the multi-stage filling method is 3*(1±20%) seconds (s);
wherein in a second filling stage, the filling pressure is 2300*(1±20%) kgf/mm², the filling speed is 45*(1±20%) mm/s, the injection molding material is transferred from the first filling position until the screw reaches a second filling position or until the maximum filling period is reached, the maximum filling period is reached, wherein the second filling position is 12±3 mm away from the final position to be reached by the injection molding material;
wherein in a third filling stage, the filling pressure is 2300*(1±20%) kgf/mm², the filling speed is 25*(1±20%) mm/s, the injection molding material is transferred from the second filling position until the screw reaches a pressure holding switch position, wherein the pressure holding switch position is 6±3 mm way from the final position to be reached by the injection molding material.

15. The molding process according to claim 9, wherein in the step of after the injection molded part is formed, switching the mold cavity to the pressure holding state to perform pressure holding on the injection molded part, a multi-stage pressure holding method is performed;
wherein during pressure holding: in a first pressure holding stage, a pressure holding speed is 25*(1±15%) mm/s, a first holding time is 1.3*(1±20%) s, and a holding pressure is 1000*(1±15%) kgf/mm²; and
in a second pressure holding stage, the pressure holding speed is 25*(1±15%) mm/s, a second holding time is 2*(1±20%) s, and the holding pressure is 900*(1±15%) kgf/mm².

16. The molding process according to claim 9, wherein in the step of opening the cooling channel after the pressure holding is completed, and cooling the mold and the injection molded part to the second preset temperature, a cooling time is 30*(1±20%) s, and the second preset temperature is 85-95° C..

17. The molding process according to claim 9, wherein in the step of opening the mold and ejecting the injection molded part, a multi-stage mold-opening method is performed;
when the mold is opened, a front mold and a rear mold of the mold move relative to each other at a mold opening speed that first increases and then decreases until reaching a maximum mold opening position, then the injection molded part is ejected and demolded by an ejector pin.

18. An application, comprising:
applying the surface microstructure according to claim 1 to an inner surface of a plastic product, so as to enable diffuse reflection and absorption of incident light on the inner surface of the plastic product.

19. An application, comprising:
applying the surface microstructure according to claim 1 on a camera module, so as to reflect and absorb incident light that enters the camera module non-vertically.

20. An application, comprising:
applying the plastic product comprising the surface microstructure prepared by the molding process according to claim 1 on a camera module, so as to reflect and absorb incident light that enters the camera module non-vertically.
